(19) United States
(12) Patent Application Publication
(10) Pub. No.: US 2023/0107035 A1
(43) Pub. Date: Apr. 6, 2023

(54) COVER MEMBER

(71) Applicant: FALTEC CO. LTD., Kawasaki-shi (JP)

(72) Inventor: Ryuji SHUKURI, Kawasaki-shi (JP)

(21) Appl. No.: 17/910,106

(22) PCT Filed: Mar. 16, 2021
(86) PCT No.: PCT/JP2021/010557

§ 371 Date: Sep. 8, 2022

(30) Foreign Application Priority Data
Mar. 18, 2020 (JP) 2020-048143

(51) Int. Cl. B60R 19/52

(52) U.S. Cl. CPC B60R 19/52

(57) ABSTRACT

A cover member (1) includes a curved upper surface (U1) that covers an upper wall portion (U) of a radiator grill (R) from above, wherein the curved upper surface (U1) includes a sealing material dispositioning region (R1) in which a foam sealing material (S) is provided and which is surrounded by a frame-shaped protruding portion (1b), and a sealing material non-dispositioning region (R2) disposed adjacent to the sealing material dispositioning region (R1), in which the foam sealing material (S) is not provided, and a maximum curvature (C1) of the upper surface (U1) in the sealing material dispositioning region (R1) is set to be smaller than a maximum curvature (C2) of the upper surface (U1) in the sealing material non-dispositioning region (R2).

### TECHNICAL FIELD

The present invention relates to a cover member.

Priority is claimed on Japanese Patent Application No. 2020-048143, filed Mar. 18, 2020, the content of which is incorporated herein by reference.

### BACKGROUND ART

In general, a radiator is disposed inside an engine room, and a grill that prevents foreign objects from entering while forming an exterior appearance of a vehicle is disposed in the front of the radiator. Typically, an upper wall portion of the grill is disposed below a hood that opens and closes the engine room and is hidden by the hood while the hood is in a closed state. A cover member that covers and hides a part of the engine room may be connected to such an upper wall portion of the grill even when the hood is open.

### CITATION LIST

### Patent Document

[Patent Document 1]

Japanese Unexamined Utility Model Application No. S62-30961

### SUMMARY OF INVENTION

### Technical Problem

A foam sealing material may be disposed on an upper surface of a cover member in order to prevent rainwater or foreign objects from entering the engine room. Such a foam sealing material is formed of a foam material having cushioning properties, and is interposed between the cover member and the hood in a compressed state by closing the hood to fill a gap between the cover member and the hood. Such a foam sealing material is attached to the upper surface of the cover member by an adhesive. When the upper surface of the cover member is curved with a large curvature however, a part of a lower surface of the foam sealing material may be peeled off from the upper surface of the cover member due to the restitutive force of the foam sealing material.

When the foam sealing material peels off in this manner, the sealing properties may deteriorate, or the replacement interval of the foam sealing material may be shortened. In many cases, the upper surface of the cover member is curved according to the shape of the hood, and in a case where the hood is greatly curved, a portion curved with a large curvature is likely to occur on the upper surface of the cover member.

The present invention has been made in view of the above-described problems, and an object thereof is to prevent the foam sealing material, which is a cover member that covers the upper wall portion of the vehicle grill and is attached to the upper surface of the cover member by an adhesive, from peeling off.

### Means for Solving the Problem

In a first aspect of the present invention, a cover member including a curved upper surface that covers an upper wall portion of a vehicle grill from above is provided, wherein the curved upper surface includes a sealing material dispositioning region which is surrounded by a protruded portion in which a foam sealing material is provided, and a sealing material non-dispositioning region disposed adjacent to the sealing material dispositioning region, in which the foam sealing material is not provided, and a maximum curvature of the upper surface in the sealing material dispositioning region is set to be smaller than a maximum curvature of the upper surface in the sealing material non-dispositioning region.

In a second aspect of the present invention, according to the above first aspect, the cover member has a base portion that protrudes upwards with respect to the surroundings and extends in the direction of vehicle width. The sealing material dispositioning region and the sealing material non-dispositioning region are disposed adjacent to each other on an upper surface of the base portion in an extension direction of the base portion.

In a third aspect of the present invention, according to the above second aspect, a central portion of the sealing material non-dispositioning region is curved so as to bulge downwards on a cross section orthogonal to the extension direction of the base portion, and a portion having the maximum curvature in the sealing material non-dispositioning region is provided in the central portion.

### Advantageous Effects of Invention

According to the present invention, a sealing material dispositioning region for disposing a foam sealing material is surrounded by a protruding portion. For this reason, during installation work of the foam sealing material, it becomes clear to which a region an adhesive agent, or a primer for improving adhesion between the adhesive agent and the foam sealing material is applied, and the adhesive agent or primer are applied to the sealing material dispositioning region with certainty, thereby improving the adhesion strength between the foam sealing material and the cover member. Moreover, according to the present invention, the sealing material dispositioning region is curved such that the maximum curvature becomes smaller with respect to an adjacent sealing material non-dispositioning region. That is, according to the present invention, the upper surface of the sealing material dispositioning region is a smoother surface than the sealing material non-dispositioning region. Therefore, a restitutive force of the foam sealing material attached to the sealing material dispositioning region can be reduced so as to prevent the foam sealing material from peeling off. Therefore, according to the present invention, it is possible to prevent the foam sealing material, which is a cover member that covers the upper wall portion of the vehicle grill and is attached to the upper surface of the cover member by an adhesive, from peeling off.

### BRIEF DESCRIPTION OF DRAWINGS

FIG. 1 is an enlarged front perspective view of a vehicle including a cover member according to an embodiment of the present invention.

FIG. 2 is a perspective view schematically showing a part of the cover member according to an embodiment of the present invention.

FIG. 3 is a cross-sectional view taken along line A-A of FIG. 2.

FIG. 4 is a cross-sectional view taken along line B-B of FIG. 2.

### DESCRIPTION OF EMBODIMENTS

Hereinafter, an embodiment of a cover member according to the present invention will be described with reference to the drawings.

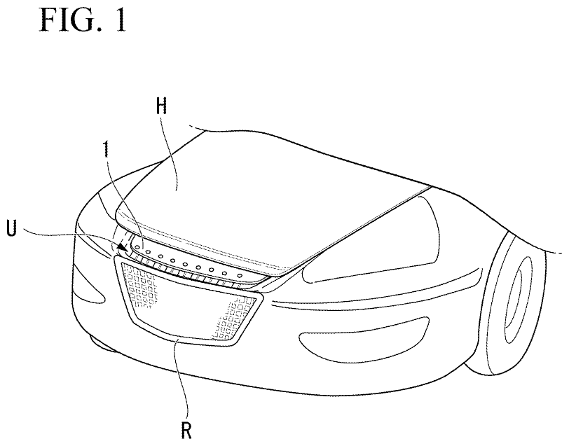

FIG. 1 is an enlarged front perspective view of a vehicle including a cover member 1 of the present embodiment. As shown in FIG. 1, the vehicle includes a radiator grill R (vehicle grill). The radiator grill R is provided in a central portion of a front surface of the vehicle and is disposed in front of the radiator provided inside an engine room. The radiator grill R is, for example, a member in which a surface of a resin substrate is plated and is fixed to a vehicle body frame (not shown). Further, the radiator grill R is disposed below a front edge of a hood H that opens and closes the engine room and has a design portion that is visually recognized from the outside when the hood H is closed, and a portion that is not visually recognized from the outside when the hood H is closed. In the present embodiment, the radiator grill R has an upper wall portion U disposed at the uppermost part of a portion that extends from a rear surface of the design portion toward a rear side of the vehicle and is not visually recognized from the outside when the hood H is closed, as a portion that is not visually recognized from the outside when the hood H is closed. Furthermore, FIG. 1 shows a state in which the hood H is not completely closed, and the upper wall portion U is visually recognized.

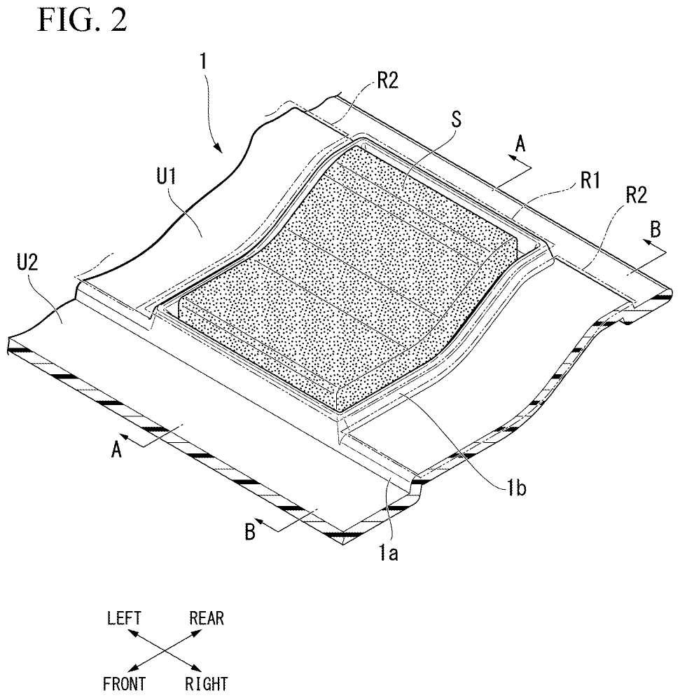

The cover member 1 of the present embodiment is a plate-shaped member that covers the upper wall portion U of the radiator grill R from above and is disposed inside the engine room. FIG. 2 is a perspective view schematically showing a part of the cover member 1. As shown in this drawing, the foam sealing material S is disposed on an upper surface U1 of the cover member 1.

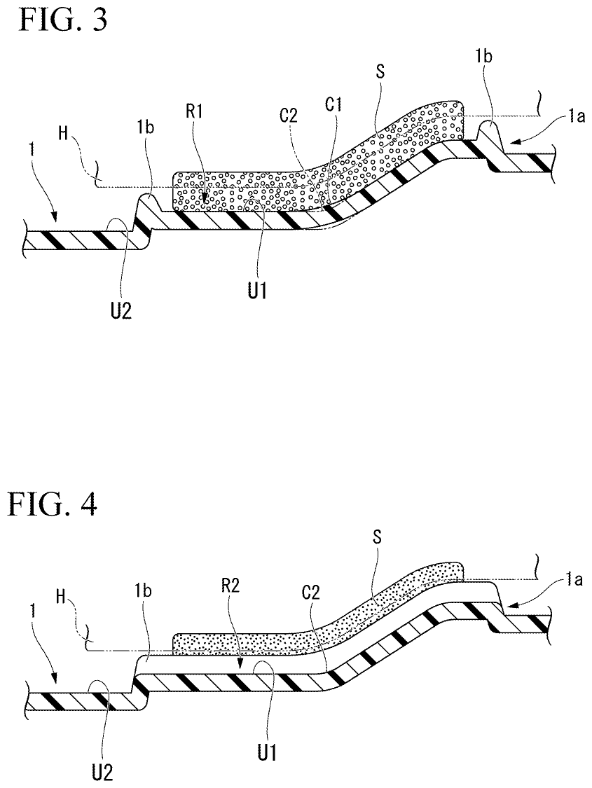

The foam sealing material S is, for example, a sponge-like sealing material made of synthetic rubber and can be easily compressed and deformed. The foam sealing material S can be easily and elastically deformed but is a sheet-shaped member in which the upper and lower surfaces thereof are flat when no external forces are at play. Such a foam sealing material S is attached to the upper surface U1 of the cover member 1 via a primer and an adhesive. FIG. 3 is a cross-sectional view taken along line A-A of FIG. 2. As shown in this drawing, a thickness dimension of the foam sealing material S is larger than a separation distance dimension from the upper surface U1 of the cover member 1 to a lower surface of the hood H in a closed state. Such a foam sealing material S is sandwiched between the cover member 1 and the hood H in a compressed state to fill a gap between the cover member 1 and the hood H. In this way, the foam sealing material S prevents rainwater and foreign objects from entering the engine room by filling the gap between the cover member 1 and the hood H. Furthermore, a single or a plurality of foam sealing materials S are provided with respect to the upper surface U1 of the cover member 1.

The cover member 1 of the present embodiment extends in a vehicle width direction and is provided at a front end of the engine room so as to cover from a right end to a left end of the engine room. The cover member 1 is made of resin, which may be formed via injection molding for example. As shown in FIG. 3, in the present embodiment, on a cross section orthogonal to the vehicle width direction, an intermediate portion positioned above the cover member 1 of the hood H is curved so as to bulge downward. The cover member 1 is also curved such that a central portion thereof bulges downward on a cross section orthogonal to the vehicle width direction as a whole according to a shape of the hood H.

As shown in FIG. 2, the cover member 1 has a base portion 1a provided to extend in the vehicle width direction. In a case where a surface along the hood H at regular intervals is used as a reference surface, the base portion 1a is a portion protruding above the reference surface. In the present embodiment, since the hood H is curved as described above, the reference surface is also curved in the same manner as the hood H, and the base portion 1a protrudes upwards with respect to the curved reference surface. That is, the base portion 1a is positioned above the reference surface as compared with the upper surface U2 of a portion where the base portion 1a is not provided. The portion where the base portion 1a is not provided is adjacent to the upper surface U1 of the cover member 1 (the upper surface of the base portion 1a).

As shown in FIG. 2, on the upper surface U1 of the base portion 1a, a sealing material dispositioning region R1 in which the foam sealing material S is disposed, and a sealing material non-dispositioning region R2 in which the foam sealing material S is not disposed and an upper surface thereof is exposed are provided adjacent to each other. As shown in FIG. 2, in the present embodiment, the sealing material non-dispositioning regions R2 are disposed adjacent to the left and the right sides of the sealing material dispositioning region R1.

The sealing material dispositioning region R1 is surrounded by a frame-shaped protruding portion 1b provided on the upper surface U1 of the cover member 1. The frame-shaped protruding portion 1b protrudes upwards from the upper surface U1 of the base portion 1a and is provided so as to surround the sealing material dispositioning region R1 in a plan view. A front edge portion of the frame-shaped protruding portion 1b is disposed on a front-end portion of the base portion 1a, and a rear edge portion of the frame-shaped protruding portion 1b is disposed on a rear end portion of the base portion 1a.

FIG. 3 is a cross-sectional view taken along line A-A of FIG. 2 as described above and is a cross-sectional view passing through the sealing material dispositioning region R1. FIG. 4 is a cross-sectional view taken along line B-B of FIG. 2 and is a cross-sectional view passing through the sealing material non-dispositioning region R2. As shown in FIG. 4, the sealing material non-dispositioning region R2 is curved such that a central portion thereof bulges downward on a cross section orthogonal to an extension direction (vehicle width direction) of the base portion 1a and is provided with a portion having the maximum curvature (maximum curved portion C2) in the central portion thereof. Further, as shown in FIG. 3, the sealing material dispositioning region R1 is also curved such that a central portion thereof bulges downward on a cross section orthogonal to an extension direction (vehicle width direction) of the base portion 1a and is provided with a portion having the maximum curvature (maximum curved portion C1) in the central portion thereof.

FIG. 3 shows a shape of the base portion 1a in the sealing material non-dispositioning region R2 superimposed with virtual lines. As shown in this drawing, in the present embodiment, in a central portion of the cross section orthogonal to the extension direction (vehicle width direction) of the base portion 1a, an upper surface of the sealing material dispositioning region R1 is a curved surface that is smoother than an upper surface of the sealing material non-dispositioning region R2. That is, a curvature of the maximum curved portion C1 of the sealing material dispositioning region R1 is smaller than a curvature of the maximum curved portion C2 of the sealing material non-dispositioning region R2. As described above, in the cover member 1 of the present embodiment, the maximum curvature of the upper surface U1 in the sealing material dispositioning region R1 is set to be smaller than the maximum curvature of the upper surface U1 in the sealing material non-dispositioning region R2.

As described above, the foam sealing material S is attached to the sealing material dispositioning region R1 via a primer and an adhesive. That is, in the present embodiment, the foam sealing material S is attached to the sealing material dispositioning region R1 having a smaller curvature in the maximum curved portion C1 as compared with the sealing material non-dispositioning region R2.

The cover member 1 of the present embodiment is formed for example, by resin injection molding. That is, the cover member 1 is formed by filling the inside of a mold having a cavity space matching a shape of the cover member 1 with a molten resin, cooling the molten resin, then curing the molten resin. In a case where the foam sealing material S is attached to the cover member 1 of the present embodiment, first, a primer is applied to the sealing material dispositioning region R1. This primer serves as a base layer for improving the adhesive strength between an adhesive and the cover member 1 of the present embodiment. In the present embodiment, a region surrounded by the frame-shaped protruding portion 1b is defined as the sealing material dispositioning region R1. Therefore, when applying a primer, an operator may apply the primer to a range surrounded by the frame-shaped protruding portion 1b, using the frame-shaped protruding portion 1b as a guide, thereby easily applying the primer to the sealing material dispositioning region R1. Furthermore, in a case where the adhesive strength between an adhesive and the cover member 1 can be sufficiently ensured without applying the primer, applying the primer is not necessary.

Subsequently, an adhesive for bonding the foam sealing material S is applied to the sealing material dispositioning region R1. In the present embodiment, a region surrounded by the frame-shaped protruding portion 1b is defined as the sealing material dispositioning region R1. Therefore, when applying an adhesive, the operator can apply the adhesive to a range surrounded by the frame-shaped protruding portion 1b, using the frame-shaped protruding portion 1b as a guide, thereby easily applying the adhesive to the sealing material dispositioning region R1.

After the adhesive is applied to the sealing material dispositioning region R1 in this way, the foam sealing material S is attached to the sealing material dispositioning region R1. In the present embodiment, a region surrounded by the frame-shaped protruding portion 1b is defined as the sealing material dispositioning region R1. Therefore, when disposing the foam sealing material S, the operator can apply the foam sealing material S to a range surrounded by the frame-shaped protruding portion 1b by using the frame-shaped protruding portion 1b as a guide, thereby easily applying the foam sealing material S to the sealing material dispositioning region R1.

An entire lower surface of the foam sealing material S attached to the sealing material dispositioning region R1 in this way is bonded to the upper surface U1 of the cover member 1 in the sealing material dispositioning region R1. Due to the bonding force of an adhesive, the foam sealing material S is held in a curved state according to a shape of the upper surface U1 of the cover member 1 in the sealing material dispositioning region R1.

The cover member 1 of the present embodiment covers the upper wall portion U of the radiator grill R from above. In addition, in the cover member 1 of the present embodiment, the sealing material dispositioning region R1 in which the foam sealing material S is provided and surrounded by the frame-shaped protruding portion 1b, and the sealing material non-dispositioning region R2 in which the foam sealing material S is not provided are disposed adjacent to the curved upper surface U1, and the maximum curvature of the upper surface U1 in the sealing material dispositioning region R1 is set to be smaller than the maximum curvature of the upper surface U1 in the sealing material non-dispositioning region R2.

According to the cover member 1 of the present embodiment as described above, the sealing material dispositioning region R1 in which the foam sealing material S is disposed is surrounded by the frame-shaped protruding portion 1b. For this reason, during the attachment work of foam sealing material S, a region to which an adhesive or a primer for improving the adhesiveness between the adhesive and the foam sealing material S is applied becomes clear, and the adhesive or primer can certainly be applied to the sealing material dispositioning region R1, thereby improving the adhesive strength between the foam sealing material S and the cover member 1. Moreover, according to the cover member 1 of the present embodiment, the sealing material dispositioning region R1 is curved such that the maximum curvature becomes smaller than the sealing material non-dispositioning region R2 adjacent thereto. That is, according to the cover member 1 of the present embodiment, the upper surface of the sealing material dispositioning region R1 is a smoother surface than the sealing material non-dispositioning region R2. Therefore, the restitutive force of the foam sealing material S attached to the sealing material dispositioning region R1 can be reduced to prevent the foam sealing material S from peeling off.

In addition, the cover member 1 of the present embodiment has the base portion 1a that protrudes upwards with respect to the surroundings, and extends in the vehicle width direction, where the sealing material dispositioning region R1 and the sealing material non-dispositioning region R2 are disposed on the upper surface U1 of the base portion 1a to be adjacent to each other in the extension direction of the base portion 1a. According to the cover member 1 of the present embodiment as described above, since the sealing material dispositioning region R1 is provided on the upper surface U1 of the base portion 1a, visual recognition of the sealing material dispositioning region R1 becomes easier.

In addition, in the cover member 1 of the present embodiment, a central portion of the sealing material non-dispositioning region R2 is curved so as to bulge downward on a cross section orthogonal to the extension direction of the base portion 1a, and a portion having the maximum curvature (maximum curved portion C2) in the sealing material non-dispositioning region R2 is provided in the central portion thereof. Even when the maximum curved portion C2 is provided in the central portion of the sealing material non-dispositioning region R2 as described above, the upper surface of the sealing material dispositioning region R1 has a smooth surface, compared with the sealing material non-dispositioning region R2, making it possible to prevent the foam sealing material S from peeling off with more certainty.

Although the preferred embodiments of the present invention have been described above with reference to the accompanying drawings, the present invention is not limited to the above embodiments. The various shapes, combinations, and the like of respective constituent members shown in the above-described embodiments are merely examples, and various changes can be made based on design requirements and the like within the scope of the present invention defined in the claims.

For example, in the above embodiment, a configuration in which both the sealing material dispositioning region R1 and the sealing material non-dispositioning region R2 are provided on the upper surface U1 of the base portion 1a has been described. However, the present invention is not limited thereto. The base portion 1a may be locally provided in the vehicle width direction for example, and only the sealing material dispositioning region R1 may be provided on the upper surface U1 of the base portion 1a.

### INDUSTRIAL APPLICABILITY

According to the present invention, it is possible to provide a cover member that covers an upper wall portion of a vehicle grill, which can prevent a foam sealing material attached to an upper surface of the cover member by an adhesive from peeling off.

### REFERENCE SIGNS LIST

1: Cover Member

1a: Base Portion

1b: Frame-Shaped Protruding Portion (Protruding Portion)

C1: Maximum Curved Portion

C2: Maximum Curved Portion

H: Hood

R: Radiator Grill (Vehicle Grill)

R1: Sealing Material Dispositioning Region

R2: Sealing Material Non-Dispositioning Region

S: Foam Sealing Material

1. A cover member comprising:
a curved upper surface that covers an upper wall portion of a vehicle grill from above,
wherein the curved upper surface includes
a sealing material dispositioning region in which a foam sealing material is provided and which is surrounded by a protruding portion, and
a sealing material non-dispositioning region disposed adjacent to the sealing material dispositioning region, in which the foam sealing material is not provided, and
a maximum curvature of the upper surface in the sealing material dispositioning region is set to be smaller than a maximum curvature of the upper surface in the sealing material non-dispositioning region.

2. The cover member according to claim 1, wherein
the cover member has a base portion that protrudes upwards with respect to surroundings and extends in a vehicle width direction, and
the sealing material dispositioning region and the sealing material non-dispositioning region are disposed adjacent to each other on an upper surface of the base portion in an extension direction of the base portion.

3. The cover member according to claim 2, wherein
a central portion of the sealing material non-dispositioning region is curved to bulge downward on a cross section orthogonal to the extension direction of the base portion, and
a portion having a maximum curvature in the sealing material non-dispositioning region is provided in the central portion.
